(19) United States
(12) Patent Application Publication
(10) Pub. No.: US 2016/0340497 A1
(43) Pub. Date: Nov. 24, 2016

(54) CARBON BLACK FOR USE IN RUBBER PROCESSING

(71) Applicant: Aditya Birla Nuvo Limited, Mumbai (IN)

(72) Inventors: Ranjan Ghosal, Mumbai (IN); Meena Shukla, Singapore (SG); Sunil Kumar Narayanan, Mumbai (IN); Brindha Mohandoss, Mumbai (IN)

(21) Appl. No.: 15/135,683

(22) Filed: Apr. 22, 2016

Related U.S. Application Data
(63) Continuation of application No. 13/992,874, filed on Aug. 22, 2013, now abandoned.

(30) Foreign Application Priority Data
Dec. 13, 2010 (IN) 3377/MUM/2010

(51) Int. Cl. C08K 9/04; C09C 1/56

(52) U.S. Cl. CPC C08K 9/04; C09C 1/56

(57) ABSTRACT

A composition containing carbon black and a naturally occurring oil for use in rubber processing.

### FIELD OF THE INVENTION

This invention relates to an improved carbon black for use in rubber processing.

### BACKGROUND OF THE INVENTION

Carbon black is a material used as a performance-enhancing filler in rubber and other polymers. The reinforcing action of carbon black depends on the physical interaction between carbon black and the polymeric matrix. The performance enhancement provided by the carbon black depends to a large extent on the effectiveness of the process used to prepare the mixture of carbon black, polymer and other additives.

Carbon black is added to the polymer, most typically rubber, in a high-shear mixer so as to incorporate it into the matrix and render it an indivisible part of the rubber compound. In addition to carbon black, a variety of chemicals and processing aids are added to the polymer so as to reduce the time and energy required for processing. One of the commonly used processing aids is a class of aromatic oils that acts a softener or plasticizer for the mixture or rubber, carbon black and other components, enabling the mixing device to efficiently knead the mixture into a homogeneous whole. Homogeneity of the mixture is very important in ensuring consistency in the final product properties, e.g. tires, hoses, rubber profiles and the like. A non-homogeneous mixture can result in failure of the product in its end-use application. Thus, the processing oils used serve a key function in the quality of the final product, besides ensuring an efficient and effective mixing process.

However, aromatic oils used in rubber processing typically contain high proportions (up to 85%) by weight of aromatic compounds, of which 15% or more could consist of polynuclear aromatic compounds. Polynuclear aromatic compounds are known to be toxic and possibly carcinogenic. Hence, their use is now being regulated the world over. Tires are a major source of hazardous polynuclear aromatic compounds-which are leached into the air and water table from tires and discarded tyre components. Rubber product manufacturers are considering other options to minimize the use of processing oils that contain polynuclear aromatic compounds.

The alternatives to aromatic processing oils, that are now being used by rubber processors, are of petroleum origin and thus consist of a non-renewable resource.

Additionally, by requiring that a processing oil be added to the rubber compound, it is necessitated for the rubber processor to carry inventories of the oil, to have a process for adding it to the compound, and to mix the oil uniformly with the rubber compound.

Further, there is a global push to use a larger proportion of renewable materials in all manufactured goods, i.e. to minimize the use of non-renewable resources such as petroleum and petroleum-derived products.

### OBJECTS OF THE INVENTION

It is therefore an object of this invention to propose an improved carbon black for use in rubber processing, which can obviate the use of a rubber processing oil in the manufacture of rubber goods.

Another object of this invention is to present an improved carbon black which imparts equivalent or better properties to the rubber end product, even without adding any processing oil to the rubber compound.

A still further object of the invention is to increase the renewable content of the rubber compound, i.e. the proportion if the rubber compound that comes from renewable resources.

Yet another object of the invention is to use the carbon black as a carrier for chemicals useful in the processing of rubber compounds.

While some of these objectives can be met by directly adding a renewable processing agent to the rubber compound, it is a far more elegant alternative to provide the additive incorporated into the carbon black, which mixes very well with rubber and allows the additive to therefore mix well with the rubber as a matter of course and with minimal work.

These and other facets of the invention will be apparent on reading the ensuing description.

### BRIEF DESCRIPTION OF THE INVENTION:

According to this invention is provided an improved carbon black for use in rubber processing.

In accordance with this invention, carbon black is treated with a substance (“treatment agent”) originating, in a renewable resource to improve its properties, so that no rubber processing oil needs to be used during the rubber compound mixing process. The treated carbon black of the invention thus obviates the need for the use of a rubber processing oil containing hazardous polynuclear aromatic compounds, or one that originates from a non-renewable resource like petroleum.

The treatment agent can consist of any substance that confers the required properties in the mixture of rubber, carbon black and other chemicals. The treatment agent may preferably be of plant origin and could be in any form such as oils, fibres and such, and enhances the properties of carbon black. In a preferred embodiment, the carbon black is treated with a naturally occurring oil, resulting in a mixed rubber compound of comparable or improved properties to the reference compound mixed with standard rubber processing oil. The oils used may be an edible or non-edible vegetable oil, such as rice bran oil (Oruza sativa.), neem oil (Azadirachta indica), Karanjia oil (Milletia pinnata), palm oil, mahua oil (Madhuca longifolia), rubber seed oil or other oils that are commonly available. It is further preferred to use oils with a high content of linoleic and oleic acids as these are thought to improve the characteristics of the final rubber mixture. The treatment agent can be added in quantities from 1% by weight to 50% by weight of the carbon black.

### EXAMPLE 1

10 ml of rice bran oil was mixed with 100 ml of acetone, which in turn was mixed thoroughly with 100 gm of N220 carbon black. The treated carbon black was dried in an oven at 70 deg. C. The treated, dried carbon black was subsequently mixed into a rubber compound with a standard recipe and processing technique in a roll mill while omitting to add any processing oil, and the properties of the resultant product were tested.

For comparison, two additional batches of rubber compound were prepared using 1) conventional carbon black and aromatic processing oil and 2) conventional carbon black and no processing oil. All three rubber compounds were also aged at 70 deg. C. for 72 hours and tested again to determine the loss of properties on aging.

The properties of the rubber compound obtained using the preferred embodiment (i.e. using treated carbon black but no aromatic processing oil), show properties similar to or better than, the rubber compound that was obtained using conventional carbon black and aromatic processing oil. By comparison, the rubber compound prepared with conventional (untreated) carbon black and no processing oil, suffers a noticeable loss in properties. Further, the properties of the rubber compound that uses the carbon black of this invention, was less prone to deterioration of its properties on aging. The comparison is shown in Table 1.

TABLE 1
Comparison of rubber compound properties using untreated
carbon blacks and treated carbon blacks of the invention

| | | | | % Change in |
|---|---|---|---|---|
| | | | | Tensile |
| | | | | Properties after |
| | Mooney | Tensile Properties | | ageing |
| | Viscosity | Tensile | Elongation | Change in |
| | ML(1 + 4) | Strength, | @ Break, | Tensile |
| Formulation | 100 | MPa | % | Strength, % |
| Rubber compound | 75.0 | 26.58 | 466.25 | −6.19 |
| processed with | | | | |
| Aromatic Oil | | | | |
| Rubber compound | 91.5 | 25.88 | 379.75 | −7.32 |
| processed without | | | | |
| Aromatic Oil | | | | |
| Rubber compound | 76.3 | 27.60 | 490.40 | −2.83 |
| processed without | | | | |
| Aromatic Oil, but | | | | |
| using the carbon | | | | |
| black of the present | | | | |
| invention | | | | |

### EXAMPLE 2

10 ml of rice bran oil was mixed with 100 ml of acetone, which in turn was mixed thoroughly with 100 gm of N220 carbon black. The treated carbon black was dried in an oven at 70 deg. C. The treated, dried carbon black was subsequently mixed into a rubber compound with a standard recipe and processing technique in a roll mill while omitting to add any processing oil, and the properties of the resultant product were tested. For comparison, the same procedure was followed for preparing a compound using conventional N220 carbon black, and using processing oil to prepare the rubber compound.

The properties of the two rubber compounds are compared in Table 2. Row 1 shows the Mooney Viscosity (an important parameter in rubber processing) of the two compounds. Row 2 & 3 show Tan Delta and Heat Buildup, indicators of the energy loss from the rubber compound during its use in applications. In Rows 4, 5 & 6 other important properties of the two rubber compounds are shown to be essentially unchanged. In summary, Table 2 shows that the properties of the compound that uses the carbon black of the invention, but no processing oil, are essentially the same as that of the compound prepared using conventional carbon black and processing oil. This shows conclusively that the carbon black of the invention can be used as a substitute for conventional carbon black used with processing oil.

TABLE 2
Comparison of rubber compound properties using untreated
carbon blacks and treated carbon blacks of the invention

| | | Rubber Compound Properties | |
|---|---|---|---|
| | | Using | Using N220 |
| | | Untreated | Treated with |
| | Name of Test | N220 | Rice Bran Oil |
| 1 | Mooney Viscosity(MU) | 83.4 | 81.7 |
| 2 | Max Tan Delta | 0.173 | 0.170 |
| 3 | Heat Buildup, ° C. | 19 | 19 |
| 4 | Hardness, Shore A | 70.8 | 71.8 |
| 5 | Dispersion Rating (cured | 7.19 | 6.81 |
| | sample) 1-10 Scale | | |
| 6 | Abrasion Resistance Index | 119 | 114 |

1. An improved carbon black for use in rubber processing comprising carbon black and a naturally occurring oil.

2. The improved carbon black of claim 1, wherein the naturally occurring oil is selected from edible and non-edible vegetable oil.

3. The improved carbon black of claim 1, wherein the naturally occurring oil is selected from rice bran oil, neem oil, Karanjia oil, palm oil, mahua oil, and rubber seed oil.

4. The improved carbon black of claim 1 wherein the naturally occurring oil is added in a proportion of 1 to 50% by weight of the carbon black.

5. A rubber compound composition comprising a rubber compound and the improved carbon black of claim 1.
